(19) United States
(12) Patent Application Publication
(10) Pub. No.: US 2001/0053012 A1
(43) Pub. Date: Dec. 20, 2001

(54) Methods and apparatus for optical pulse period modulation and optical pulse signal generation

(76) Inventor: Makoto Shikata, Yokohama (JP)

Correspondence Address: VENABLE, Post Office Box 34385, Washington, DC, 20043-9998, US

(21) Appl. No.: 09/788,419

(22) Filed: Feb. 21, 2001

(30) Foreign Application Priority Data
Jun. 14, 2000 (JP) 2000-178302

(51) Int. Cl. H04B 10/04; G02F 1/35; G02F 2/02

(52) U.S. Cl. 359/184; 359/326

(57) ABSTRACT

An apparatus and a method are described for compressing/expanding a pulse period of an optical pulse or packet signal. The apparatus includes a chirp light generator for generating a chirp light of a wavelength which changes linearly from a first predetermined wavelength to a second predetermined wavelength for every predetermined number of pulses of the optical signal, a wavelength converter for generating a wavelength-converted optical signal by wavelength-converting the optical signal with the chirp light, and a wavelength dispersion device causes a propagation delay due to the wavelength dispersion to the wavelength-converted optical signal.

### BACKGROUND OF THE INVENTION

1. Field of the Invention

The present invention relates to methods and apparatus for optical pulse period modulation and optical pulse signal generation, in particular, to methods and apparatus for compressing or expanding an optical pulse period of an input optical signal.

2. Description of the Related Art

In recent years, the realization of a broad-band transmission path has been required in association with an increase in communication demands such as local area networks (LAN) or the like. Research and development is being actively pursued relating to an optical communication network using a time-division multiplexing (TDM) technique for multiplexing and demultiplexing an optical signal on a time base, since the optical communication network has an extremely large transmission capacity. An optical pulse period modulating technique for compressing and expanding a pulse period of an optical pulse signal is indispensable in order to realize the TDM network.

There is disclosed an optical pulse period compressing apparatus for compressing an optical pulse period, for example, in “A 1024-Channel Fast Tunable Delay Line for Ultrafast All-Optical TDM Networks”, Kung-Li Deng, Koo Il Kang, Ivan Glask, and Paul Prucnal, IEEE Photonics Technology Letters, pp. 1496-1498, Vol. 9, No. 11, November 1997.

FIG. 1 shows an example of a configuration of the optical pulse period compressing apparatus. There is provided a cascaded k-stages delay structure in the optical pulse period compressing apparatus. Each delay stage has an optical delay circuit Dⱼ (j=1 to k). The compressing apparatus is configured to compress an optical pulse period of an optical pulse signal (or optical clock signal) P_{IN} supplied to the apparatus into ½^{k}. For example, in case of an optical pulse period compressing apparatus having a delay structure of three stages, as shown in FIG. 2, an optical output signal (S3) of the third delay stage becomes an optical pulse period of ⅛ of that of the input optical pulse signal (P_{IN}). The output optical signal S3 has a frequency of eight times. The optical pulse signal compressed as mentioned above is extracted as a packet signal of every eight bits at a period of every eight pulses of the input optical pulse signal by using an optical switch (SW), so that an optical packet signal (P_{OUT}) can be obtained.

As an optical pulse period expanding apparatus for expanding an optical pulse period, for example, there is an apparatus disclosed by Akira Hasegawa and Hiroyuki Toda, “A Feasible All Optical soliton Based Inter-LAN Network Using Time Division Multiplexing”, IEICE Trans. Commun., pp. 1681-1686, Vol. E81-B, No. 8, August, 1998).

FIG. 3 shows an example of a configuration of an optical pulse period expanding apparatus. The operation of the optical pulse period expanding apparatus will be briefly described hereinbelow. In the apparatus, a delayed optical packet signal is generated from an input optical packet signal (P_{IN}) employing by using a loop circuit comprising an optical switch (SW1) and an optical amplifier. The input optical packet signal and a replica of the input optical packet signal are arranged on a time base at regular intervals in a photocoupler, thereby obtaining an optical signal (S1). An optical pulse signal (P_{OUT}) of which period has been expanded can be obtained by extracting one optical pulse from the optical signal (S1) at every predetermined period by using an optical switch (SW2).

The pulse period after completion is determined by a delay time of the optical delay circuit in the conventional optical pulse period compressing apparatus. It is, however, necessary to individually and precisely adjust the delay time of each optical delay circuit since the pulse period after compression is shorter than the delay time. There are, consequently, problems such that it is difficult to manufacture the apparatus and the number of parts is large. Further, there is a drawback of less flexibility since only a compression such that the optical pulse period is defined by 2⁻ⁿ (n is an integer) can be performed.

In the conventional optical pulse period expanding apparatus, there is a problem such that an SNR (signal to noise ratio) of the optical signal deteriorates since the optical pulse of the input optical packet signal passes one or more times through the optical amplifier. Further, there is a drawback that a scope of application of the technique is limited since the packet period needs to be n×n (n: the number of optical pulses of the optical packet) times or more as long as a bit period of the optical pulse.

### OBJECTS AND SUMMARY OF THE INVENTION

The present invention is made in consideration of the above problem and it is an object of the present invention to provide an optical pulse period compressing/expanding apparatus in which there is no need to perform a precise adjustment and which can be easily manufactured. Another object of the present invention is to provide an optical pulse period compressing/expanding apparatus in which an optical signal does not deteriorate and an optical pulse period can be arbitrarily adjusted thus having a high degree of flexibility.

Further, another object of the present invention is to provide an optical signal generating apparatus which can easily generate an optical pulse or an optical packet signal.

According to the present invention, there is provided an optical pulse period compressing apparatus for compressing a pulse period of an optical pulse signal, which comprises a chirp light generator for generating a chirp light of a wavelength which changes linearly from a first predetermined wavelength to a second predetermined wavelength for every predetermined number of pulses of the optical pulse signal; a photoelectric converter for converting the optical pulse signal to an electric pulse signal; an optical modulator for intensity-modulating the chirp light with the electric pulse signal to obtain a modulated optical signal; and a wavelength dispersion device which has a dispersion constant of a sign opposite to that of a wavelength change over time of the chirp light and causes or creates a propagation delay due to the wavelength dispersion to the modulated optical signal.

According to the present invention, there is provided an optical pulse period expanding apparatus for expanding a pulse period of an optical packet signal in which each optical packet includes a predetermined number of optical pulses, which comprises a chirp light generator for generating a chirp light of a wavelength which changes linearly from a first predetermined wavelength to a second predetermined wavelength synchronously with a head optical pulse and an end optical pulse of each of the optical packets; a photoelectric converter for converting the optical packet signal to an electric pulse signal; an optical modulator for intensity-modulating the chirp light with the electric pulse signal to obtain a modulated optical signal; and a wavelength dispersion device which has a dispersion constant of a same sign as that of a wavelength change over time of the chirp light and causes a propagation delay due to the wavelength dispersion to the modulated optical signal.

According to the present invention, there is provided an optical pulse period compressing apparatus for compressing a pulse period of an optical pulse signal, which comprises a chirp light generator for generating a chirp light of a wavelength which changes linearly from a first predetermined wavelength to a second predetermined wavelength for every predetermined number of pulses of the optical pulse signal; a wavelength converter for generating a wavelength-converted optical signal by wavelength-converting the optical pulse signal with the chirp light; and a wavelength dispersion device which has a dispersion constant of a sign opposite to that of a wavelength change over time of the chirp light and causes a propagation delay due to the wavelength dispersion to the wavelength-converted optical signal.

According to the present invention, there is provided an optical pulse period expanding apparatus for expanding a pulse period of an optical packet signal in which each optical packet includes a predetermined number of optical pulses, which comprises a chirp light generator for generating a chirp light of a wavelength which changes linearly from a first predetermined wavelength to a second predetermined wavelength synchronously with a head optical pulse and an end optical pulse of each of the optical packets; a wavelength converter for generating a wavelength-converted optical signal by wavelength-converting the optical pulse signal with the chirp light; and a wavelength dispersion device which has a dispersion constant of a same sign as that of a wavelength change over time of the chirp light and causes a propagation delay due to the wavelength dispersion to the wavelength-converted optical signal.

According to the present invention, there is provided an optical packet signal generating apparatus for generating an optical packet signal, which comprises an electric pulse signal generator for generating an electric pulse signal having a predetermined pulse period; a chirp light generator for generating a chirp light of a wavelength which changes linearly from a first predetermined wavelength to a second predetermined wavelength for every predetermined number of pulses of the electric pulse signal; an optical modulator for intensity-modulating the chirp light with the electric pulse signal to obtain a modulated optical signal; and a wavelength dispersion device which has a dispersion constant of a sign opposite to that of a wavelength change over time of the chirp light and causes a propagation delay due to the wavelength dispersion to the modulated optical signal.

According to the present invention, there is provided an optical pulse signal generating apparatus for generating an optical pulse signal, which comprises an electric pulse signal generator for generating an electric pulse signal having a predetermined pulse period; a chirp light generator for generating a chirp light of a wavelength which changes linearly from a first predetermined wavelength to a second predetermined wavelength for every predetermined number of pulses of the electric pulse signal; an optical modulator for intensity-modulating the chirp light with the electric pulse signal to obtain a modulated optical signal; and a wavelength dispersion device which causes a propagation delay due to the wavelength dispersion to the modulated optical signal.

According to the present invention, there is provided an optical packet signal generating apparatus for generating an optical packet signal, which comprises an electrical packet signal generator for generating an electrical packet signal in which each electrical packet includes a predetermined number of electrical pulses, a chirp light generator for generating a chirp light of a wavelength which changes linearly from a first predetermined wavelength to a second predetermined wavelength synchronously with a head electrical pulse and an end electrical pulse of each of the electrical packets; an optical modulator for intensity-modulating the chirp light with the electric packet signal to obtain a modulated optical signal; and a wavelength dispersion device which has a dispersion constant of a same sign as that of a wavelength change over time of the chirp light and causes a propagation delay due to the wavelength dispersion to the modulated optical signal.

### BRIEF DESCRIPTION OF THE DRAWINGS

FIG. 1 is a diagram schematically showing an example of a configuration of a conventional optical pulse period compressing apparatus;

FIG. 2 is a time chart for illustrating the operation of the optical pulse period compressing apparatus shown in FIG. 1;

FIG. 3 is a diagram schematically showing an example of a configuration of a conventional optical pulse period expanding apparatus;

FIG. 4 is a block diagram showing a configuration of an optical pulse period compressing/expanding apparatus according to the first embodiment of the present invention;

FIG. 5 is a time chart for illustrating the operation of the optical pulse period expanding apparatus shown in FIG. 4;

FIG. 6 is a time chart for illustrating the operation of the optical pulse period expanding apparatus according to a modification of the first embodiment shown in FIG. 5;

FIG. 7 is a time chart for illustrating the operation of an optical pulse period compressing apparatus according to the second embodiment of the present invention;

FIG. 8 is a block diagram showing a configuration of an optical pulse period compressing/expanding apparatus according to the third embodiment of the present invention;

FIG. 9 is a time chart for illustrating the pulse compressing operation of the optical pulse period compressing/expanding apparatus shown in FIG. 8;

FIG. 10 is a time chart for illustrating the pulse expanding operation of the optical pulse period compressing/expanding apparatus shown in FIG. 8;

FIG. 11 is a block diagram showing a configuration of an optical signal generating apparatus according to the fifth embodiment of the present invention; and

FIG. 12 is a block diagram showing a configuration of an optical signal generating apparatus having an electric signal reception terminal according to a modification of the fifth embodiment shown in FIG. 11.

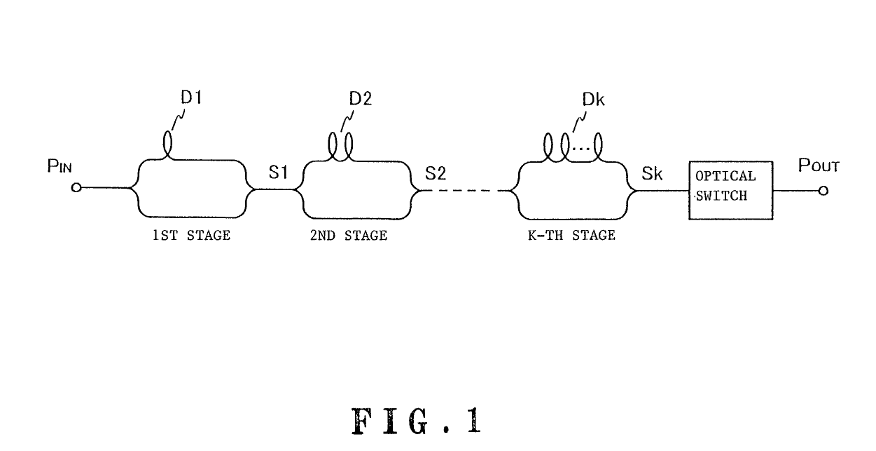

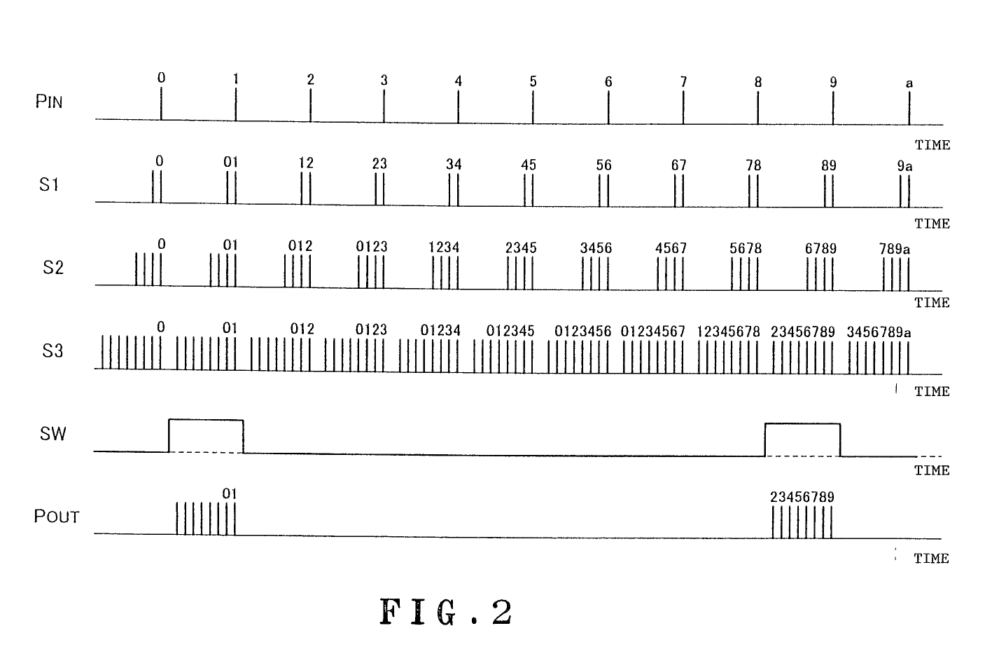

### DETAILED DESCRIPTION OF THE PREFERRED EMBODIMENTS

Embodiments of the present invention will now be described in detail hereinbelow with reference to the drawings. In the diagrams which are used in the following description, substantially equivalent component elements are designated by the same reference numerals.

First Embodiment

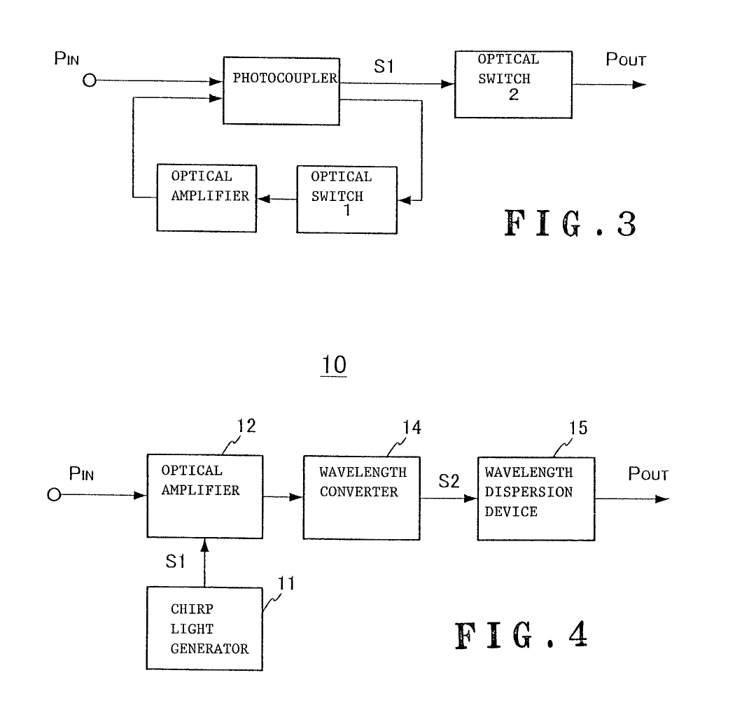

FIG. 4 is a block diagram showing a configuration of an optical pulse period compressing/expanding apparatus 10 according to the first embodiment of the present invention. In the first embodiment, the optical pulse period compressing/expanding apparatus 10 operates as an optical pulse period expanding apparatus.

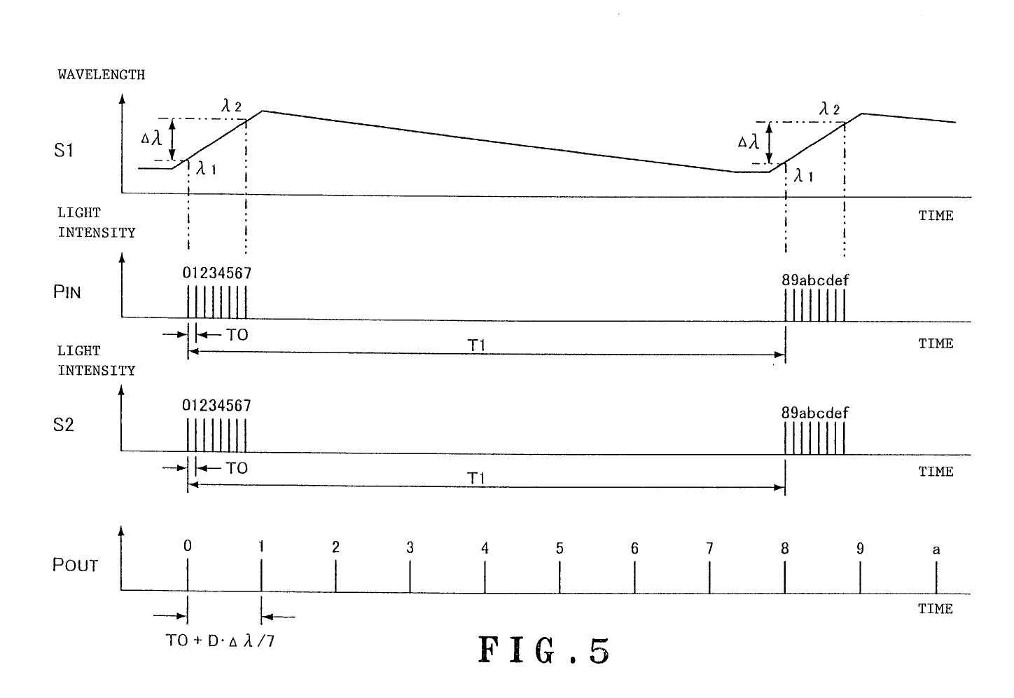

The optical packet signal (P_{IN}) is supplied to an optical -input terminal of the apparatus 10. In a photocoupler 12, the input optical packet signal is coupled with a lightwave having a wavelength-chirping (hereinafter, simply referred to as “chirp light”) S1 from a chirp light generator 11. As shown in a time chart of FIG. 5, the optical packet signal P_{IN} has a packet period of T1 and each optical packet includes eight optical pulses (8 bits) of which optical pulse period is equal to T0.

The chirp light (S1) which is generated by the chirp light generator 11 has a constant optical power as shown in FIG. 5 and its wavelength linearly increases in a range from a first predetermined wavelength (λ1) to a second predetermined wavelength (λ2) synchronously with each head optical pulse (i.e., optical pulse “0” or “8”) and an end optical pulse (i.e., optical pulse “7” or “f”) of each optical packet in the input optical packet signal P_{IN}. A change amount Δλ of the wavelength is equal to [λ2 (the second predetermined wavelength)−λ1 (the first predetermined wavelength)] and is set to a positive value (i.e., Δλ=λ2−λ1>0) in the embodiment.

The coupled optical signal in the photocoupler 12 is supplied to a wavelength converter 14 and “wavelength converted”. More particularly, the chirp light (S1) is intensity-modulated by the optical pulse, so that a wavelength of each optical pulse is equivalently “converted”. In other words, the wavelength of each optical pulse (i.e., optical pulses “0” to “7”) in the optical packet is converted so as to be equal to a wavelength of the chirp light at a time position of each of the optical pulses, so that an optical packet signal (S2) is obtained. In the optical pulses (i.e., optical pulses “0” to “7”) of the optical packet signal (S2) after completion of the wavelength conversion, therefore, the wavelengths of the adjacent optical pulses are different by Δλ/7.

Subsequently, the optical packet signal (S2) is supplied to a wavelength dispersion device 15 and a propagation delay due to wavelength dispersion is caused or created to each optical pulse. More specifically, the wavelength dispersion device 15 has a dispersion constant D (i.e., D>0 in the embodiment) of the same sign as that of a wavelength change over time (i.e., Δλ>0) of the chirp light. Each optical pulse, therefore, is subjected to the propagation delay in accordance with the wavelength difference and the optical pulse signal (P_{OUT}) in which the period of the optical pulse has been expanded so as to be T0+D×Δλ/7 is obtained.

In order to expand the optical pulse signal (P_{OUT}) so as to have a predetermined period (i.e., to equalize the period between the optical pulses “7” and “8” to the above period: T0+D×Δλ/7) as shown in FIG. 5, generally, the following equation should be satisfied when the number of optical pulses (the number of bits) of each optical packet is assumed to be N.

T0+(D×Δλ)/(N−1)=T1/N (1)

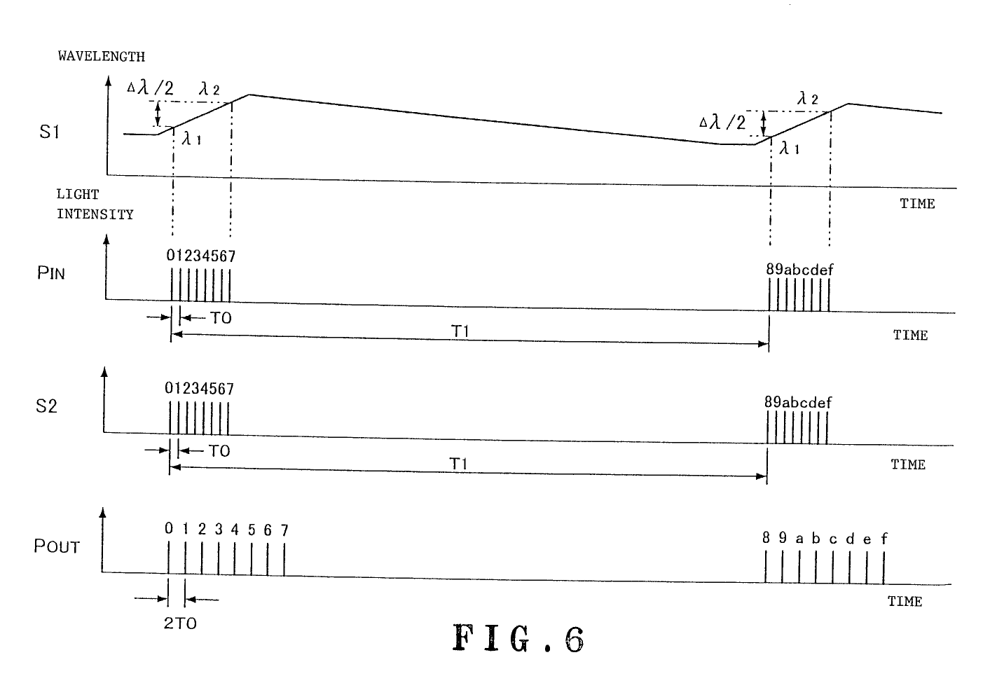

A modification of the embodiment will now be described hereinbelow with reference to a time chart shown in FIG. 6. In this case, the apparatus is constructed so as to obtain the optical packet signal (P_{OUT}) having the optical pulse period which is twice as long as that of the input optical pulse by reducing the wavelength change amount Δλ of the chirp light (S1). The dispersion constant D of the wavelength dispersion device 15 can be changed in place of the wavelength change amount Δλ of the chirp light (S1).

According to the present invention, therefore, the optical pulse period compressing/expanding apparatus can be realized in which a precise adjustment is unnecessary and the optical signal does not deteriorate. The apparatus also has a high degree of flexibility, since the optical pulse period can be arbitrarily adjusted by changing the wavelength change amount Δλ and/or the dispersion constant D. Further, the apparatus can be easily manufactured and the number of parts can be reduced, since the precise adjustment is unnecessary.

Second Embodiment

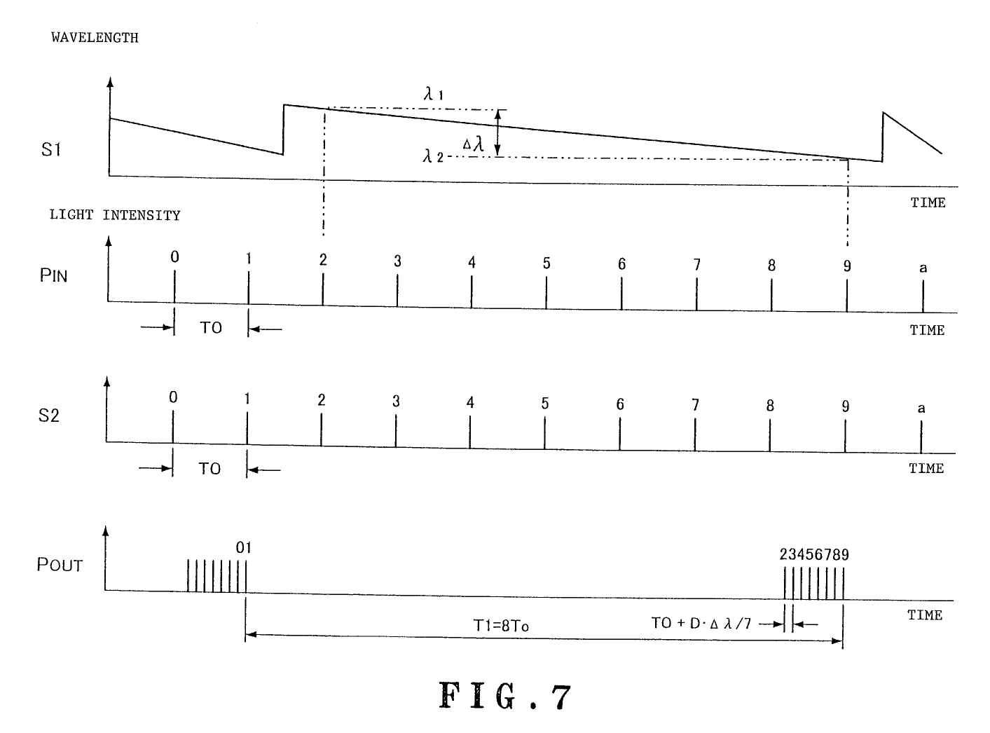

The operation of the optical pulse period compressing/expanding apparatus 10 according to the second embodiment of the present invention will now be described hereinbelow with reference to a time chart of FIG. 7. A configuration of the optical pulse period compressing/expanding apparatus 10 is similar to that of the first embodiment. The optical pulse period compressing/expanding apparatus 10 in turn operates as an optical pulse period compressing apparatus in the second embodiment.

The optical pulse signal (P_{IN}) is supplied to the optical input terminal of the optical pulse period compressing apparatus 10. The input optical pulse signal P_{IN} has a predetermined pulse period T0.

As shown in FIG. 7, the chirp light (S1) generated by the chirp light generator 11 has a constant light power and a wavelength decreases linearly from a first predetermined wavelength to a second predetermined wavelength for every predetermined number of pulses, i.e., for every eight optical pulses. The change amount Δλ of the wavelength is equal to [λ2 (the second predetermined wavelength)−λ1 (the first predetermined wavelength)] and is set to a negative value (i.e., Δλ<0) in the embodiment.

In a manner similar to the first embodiment, the optical signal coupled by the photocoupler 12 is supplied to the wavelength converter 14 and “wavelength converted”. More particularly, the wavelength of each of the optical pulses (i.e., optical pulses “2” to “9”) is converted so as to be equal to the wavelength of the chirp light at the time position of each of the optical pulses, so that the optical pulse signal (S2) is obtained. In the optical pulses (i.e., optical pulses “2” to “9”) of the optical pulse signal (S2) after completion of the wavelength conversion, therefore, the wavelengths of the adjacent optical pulses are different by Δλ/7.

Subsequently, a propagation delay is caused to the optical pulse signal (S2) by the wavelength dispersion device 15. More specifically, the wavelength dispersion device 15 has a dispersion constant D (i.e., D>0 in the embodiment) of the sign opposite to that of the wavelength change over time of the chirp light. Each optical pulse, therefore, is subjected to the propagation delay in accordance with the wavelength difference. Thus, an optical packet signal (P_{OUT}) is obtained in which the packet period is equal to T1=8T0 and the period of the optical pulse has been compressed so as to be T0+D×Δλ/7.

Third Embodiment

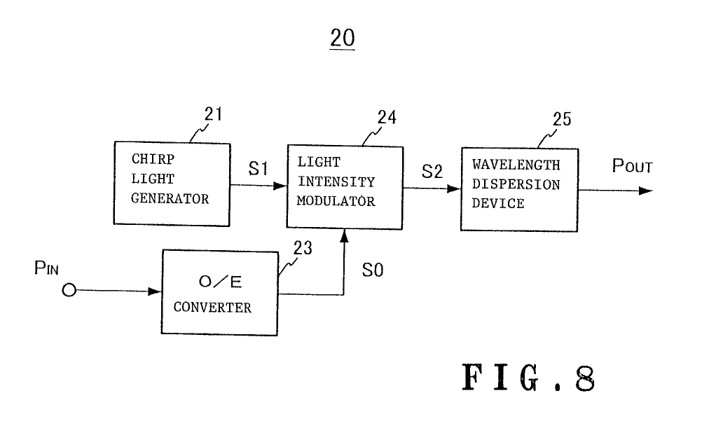

FIG. 8 is a block diagram showing a configuration of an optical pulse period compressing/expanding apparatus 20 according to the third embodiment of the present invention. In the third embodiment, the optical pulse period compressing/expanding apparatus 20 operates as an optical pulse period compressing apparatus.

The optical pulse signal (P_{IN}) having a predetermined pulse period T0 is supplied to the optical input terminal of the apparatus 20 and converted into an electric pulse signal (S0) by a photoelectric converter (O/E converter) 23 as shown in FIG. 8.

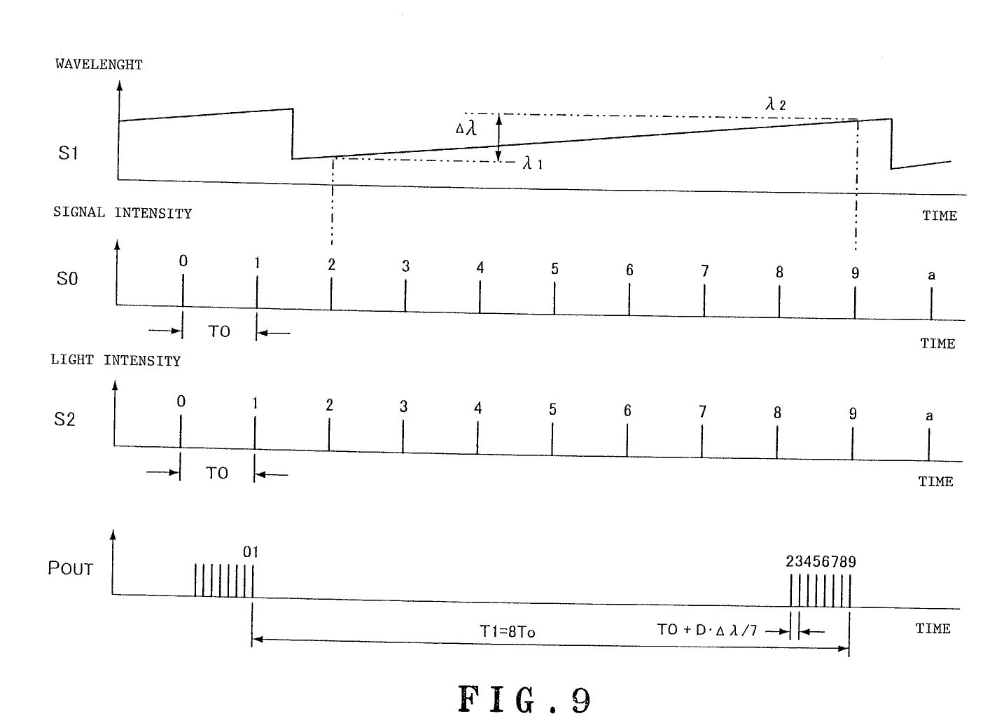

A chirp light of which wavelength changes with a predetermined period is generated by a chirp light generator 21. In more detail, as shown in FIG. 9, a wavelength of the chirp light increases linearly from a first predetermined wavelength (λ1) to a second predetermined wavelength (λ2) synchronously with a period of every predetermined number of pulses of the electric pulse signal (S0), i.e., every eight optical pulses. The change amount Δλ of the wavelength is, therefore, set to a positive value (i.e., Δλ=λ2−λ1>0) in the embodiment.

The generated chirp light is supplied to a light intensity modulator 24 and intensity modulated by the electric pulse signal (S0). An optical pulse signal (S2), in which each of the optical pulses (for example, optical pulses “2” to “9”) has the wavelength of the chirp light at the time position of each of the optical pulses (i.e., optical pulses “2” to “9”) of the electric pulse signal (S0), is obtained in the light intensity modulator 24. The optical pulse signal (S2) after completion of the intensity modulation, therefore, has the same period as that of the input optical pulse signal (P_{IN}) and the wavelengths of the adjacent optical pulses are different by Δλ/7.

Subsequently, a propagation delay is caused to the optical pulse signal (S2) in a wavelength dispersion device 25. More specifically, the wavelength dispersion device 25 has a dispersion constant D (i.e., D<0 in the embodiment) of the sign opposite to that of the wavelength change over time of the chirp light. Each optical pulse, therefore, is subjected to the propagation delay in accordance with the wavelength difference in the wavelength dispersion device 25. Thus, an optical pulse signal (P_{OUT}) can be obtained in which the packet period is equal to T1=8T0 and the period of the optical pulse has been compressed so as to be T0+D×Δλ/7.

Fourth Embodiment

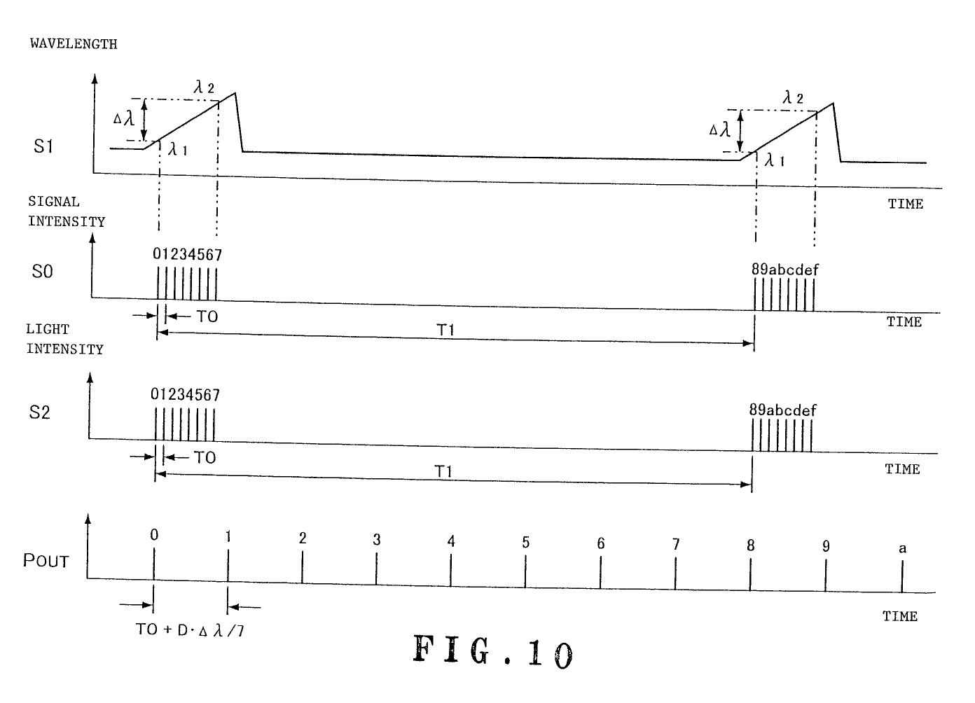

The operation of the optical pulse period compressing/expanding apparatus 20 according to the fourth embodiment of the present invention will now be described hereinbelow with reference to a time chart of FIG. 10. In the fourth embodiment, the optical pulse period compressing/expanding apparatus 20 operates as an optical pulse period expanding apparatus.

The optical packet signal (P_{IN}) including eight optical pulses (8 bits) in which the packet period is equal to T1 and the optical pulse period of each optical packet is equal to T0 is supplied to the optical input terminal of the apparatus 20. The input optical packet signal is converted into an electric pulse signal (S0) by the O/E converter 23. As shown in FIG. 10, the chirp light (S1) generated by the chirp light generator 21 has a constant light power and its wavelength increases linearly from the first predetermined wavelength (λ1) to the second predetermined wavelength (λ2) synchronously with each head optical pulse (i.e., optical pulse “0” or “8”) and an end optical pulse (i.e., optical pulse “7” or “f”) of each optical packet in the input optical packet signal. The change amount Δλ of the wavelength is set to a positive value (i.e., Δλ=λ2−λ1>0) in the embodiment.

The generated chirp light is supplied to the light intensity modulator 24 and modulated by the electric pulse signal (S0). An optical pulse signal (S2), in which each of the optical pulses (for example, optical pulses “0” to “7”) has the wavelength of the chirp light at the time position of each of the optical pulses (i.e., optical pulses “0” to “7”) of the electric pulse signal (S0) is obtained in the light intensity modulator 24. The optical pulse signal (S2) after completion of the intensity modulation has the same pulse period as that of the input optical packet signal (P_{IN}) and the wavelengths of the adjacent optical pulses are different by Δλ/7.

Subsequently, the optical packet signal (S2) is supplied to the wavelength dispersion device 25 and a propagation delay due to the wavelength dispersion is caused to each optical pulse. More specifically, the wavelength dispersion device 25 has the dispersion constant D (i.e., D>0) of the same sign as that of the wavelength change over time of the chirp light. Each optical pulse, therefore, is subjected to the propagation delay in accordance with the wavelength difference and the optical pulse signal (P_{OUT}) in which the period of the optical pulse has been expanded so as to be T0+D×Δλ/7 is obtained.

In order to expand the optical pulse signal (P_{OUT}) so as to have a predetermined period as shown in FIG. 10, the above-described equation (1) should be satisfied.

Although the case of obtaining the optical pulse signal in which the period of each optical pulse is constant has been described as an example in the embodiment. As a modification of the first embodiment, it is also possible to determine the wavelength change Δλ and/or the dispersion constant D of the chirp light so as to obtain the optical packet signal (P_{OUT}) in which the period of the optical pulse has been expanded in a manner similar to the case shown in FIG. 6.

Fifth Embodiment

FIG. 11 is a block diagram showing a configuration of an optical signal generating apparatus 30 according to the fifth embodiment of the present invention. The optical signal generating apparatus 30 has an electric signal generator 27 for generating the electric signal (S0) in place of the optical signal input terminal and the O/E converter 23 in the optical pulse period compressing/expanding apparatus 20 of the third or fourth embodiment.

In the embodiment, the electric signal generator 27 generates the electric pulse signal (S0, refer to FIG. 9) of the predetermined period T0 similar to that of the O/E converter 23 in the third embodiment and supplies it to the light intensity modulator 24. In a manner similar to the third embodiment, therefore, the optical signal generating apparatus 30 can generate the optical packet signal (P_{OUT}) by constructing the apparatus so that the product of the time change (Δλ) of the wavelength of the chirp light generated by the chirp light generator 21 and the dispersion constant D of the wavelength dispersion device 25 is negative (i.e., D×Δλ<0).

As another embodiment, the electric signal generator 27 generates the electric packet signal (S0, refer to FIG. 10) similar to that of the O/E converter 23 in the fourth embodiment, i.e., the electric packet signal including eight electric pulses (8 bits) in which the packet period is equal to T1 and the pulse period of each packet is equal to T0. In a manner similar to the fourth embodiment, the optical signal generating apparatus 30 can generate the optical pulse signal or the optical packet signal by constructing the apparatus so that the product of the time change (Δλ) of the wavelength of the chirp light generated by the chirp light generator 21 and the dispersion constant D of the wavelength dispersion device 25 is positive (i.e., D×Δλ>0).

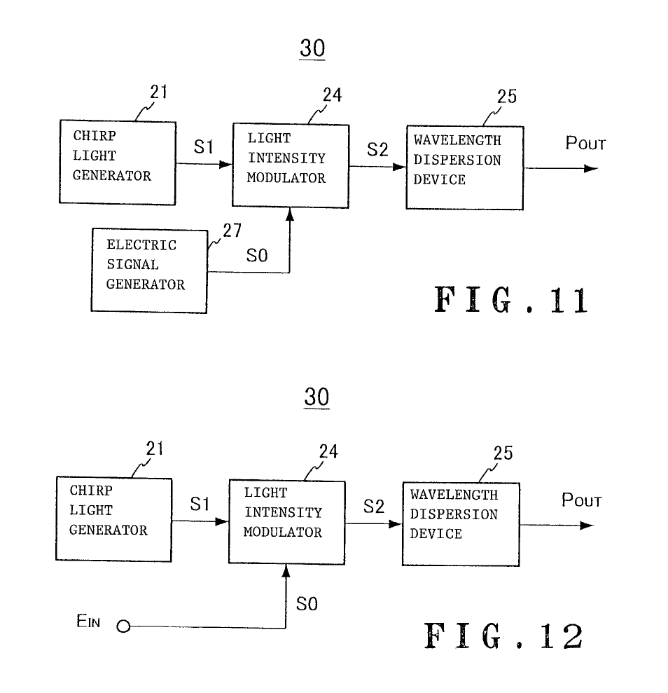

It is also possible to construct the apparatus by providing a reception terminal (E_{IN}) for receiving the electric signal as mentioned above from the outside as shown in FIG. 12 instead of providing the electric signal generator 27.

The numerical values and the like shown in the embodiments are shown as examples and can be also properly changed. The various embodiments are shown as examples and can be properly combined or modified and applied.

As will be obviously understood from the above description, according to the present invention, the optical pulse period compressing/expanding apparatus in which the precise adjustment is unnecessary and the optical signal does not deteriorate can be realized. The optical pulse period can be arbitrarily adjusted by changing the wavelength change amount Δλ and/or the dispersion constant D. The apparatus has a high degree of flexibility. Further, the apparatus can be easily manufactured and the number of parts can be reduced since the precise adjustment is unnecessary.

The invention has been described with reference to the preferred embodiments thereof. It should be understood by those skilled in the art that a variety of alterations and modifications may be made from the embodiments described above. It is therefore contemplated that the appended claims encompass all such alternations and modifications.

What is claimed is:

1. An optical pulse period compressing apparatus for compressing a pulse period of an optical pulse signal, comprising:
a chirp light generator for generating a chirp light of a wavelength which changes linearly from a first predetermined wavelength to a second predetermined wavelength for every predetermined number of pulses of said optical pulse signal;
a photoelectric converter for converting said optical pulse signal to an electric pulse signal;
an optical modulator for intensity-modulating said chirp light with said electric pulse signal to obtain a modulated optical signal; and
a wavelength dispersion device which has a dispersion constant of a sign opposite to that of a wavelength change over time of said chirp light and causes a propagation delay due to the wavelength dispersion to said modulated optical signal.

2. An optical pulse period expanding apparatus for expanding a pulse period of an optical packet signal in which each optical packet includes a predetermined number of optical pulses, comprising:
a chirp light generator for generating a chirp light of a wavelength which changes linearly from a first predetermined wavelength to a second predetermined wavelength synchronously with a head optical pulse and an end optical pulse of each of said optical packets;
a photoelectric converter for converting said optical packet signal to an electric pulse signal;
an optical modulator for intensity-modulating said chirp light with said electric pulse signal to obtain a modulated optical signal: and
a wavelength dispersion device which has a dispersion constant of a same sign as that of a wavelength change over time of said chirp light and causes a propagation delay due to the wavelength dispersion to said modulated optical signal.

3. An apparatus according to claim 2, wherein an equation
T0+(D×L)/(N−1)=T1/N
is satisfied,
where,
D: dispersion constant of said wavelength dispersion device,
L: wavelength change amount of said chirp light between said head optical pulse and said end optical pulse of said optical packet,
N: number of optical pulses of each of said optical packets,
T0: optical pulse period of said optical packet,
T1: packet period of said optical packet signal.

4. An optical pulse period compressing apparatus for compressing a pulse period of an optical pulse signal, comprising:
a chirp light generator for generating a chirp light of a wavelength which changes linearly from a first predetermined wavelength to a second predetermined wavelength for every predetermined number of pulses of said optical pulse signal;
a wavelength converter for generating a wavelength-converted optical signal by wavelength-converting said optical pulse signal with said chirp light; and
a wavelength dispersion device which has a dispersion constant of a sign opposite to that of a wavelength change over time of said chirp light and causes a propagation delay due to the wavelength dispersion to said wavelength-converted optical signal.

5. An optical pulse period expanding apparatus for expanding a pulse period of an optical packet signal in which each optical packet includes a predetermined number of optical pulses, comprising:
a chirp light generator for generating a chirp light of a wavelength which changes linearly from a first predetermined wavelength to a second predetermined wavelength synchronously with a head optical pulse and an end optical pulse of each of said optical packets;
a wavelength converter for generating a wavelength-converted optical signal by wavelength-converting said optical pulse signal with said chirp light; and
a wavelength dispersion device which has a dispersion constant of a same sign as that of a wavelength change over time of said chirp light and causes a propagation delay due to the wavelength dispersion to said wavelength-converted optical signal.

6. An apparatus according to claim 5, wherein an equation
T0+(D×L)/(N−1)=T1/N
is satisfied,
where,
D: dispersion constant of said wavelength dispersion device,
L: wavelength change amount of said chirp light between said head optical pulse and said end optical pulse of said optical packet,
N: number of optical pulses of each of said optical packets,
T0: optical pulse period of said optical packet,
T1: packet period of said optical packet signal.

7. An optical packet signal generating apparatus for generating an optical packet signal, comprising:
an electric pulse signal generator for generating an electric pulse signal having a predetermined pulse period;
a chirp light generator for generating a chirp light of a wavelength which changes linearly from a first predetermined wavelength to a second predetermined wavelength for every predetermined number of pulses of said electric pulse signal;
an optical modulator for intensity-modulating said chirp light with said electric pulse signal to obtain a modulated optical signal; and
a wavelength dispersion device which has a dispersion constant of a sign opposite to that of a wavelength change over time of said chirp light and causes a propagation delay due to the wavelength dispersion to said modulated optical signal.

8. An optical pulse signal generating apparatus for generating an optical pulse signal, comprising:
an electric pulse signal generator for generating an electric pulse signal having a predetermined pulse period;
a chirp light generator for generating a chirp light of a wavelength which changes linearly from a first predetermined wavelength to a second predetermined wavelength for every predetermined number of pulses of said electric pulse signal;
an optical modulator for intensity-modulating said chirp light with said electric pulse signal to obtain a modulated optical signal; and
a wavelength dispersion device which causes a propagation delay due to the wavelength dispersion to said modulated optical signal.

9. An optical packet signal generating apparatus for generating an optical packet signal, comprising:
an electrical packet signal generator for generating an electrical packet signal in which each electrical packet includes a predetermined number of electrical pulses,
a chirp light generator for generating a chirp light of a wavelength which changes linearly from a first predetermined wavelength to a second predetermined wavelength synchronously with a head electrical pulse and an end electrical pulse of each of said electrical packets;
an optical modulator for intensity-modulating said chirp light with said electric packet signal to obtain a modulated optical signal; and
a wavelength dispersion device which has a dispersion constant of a same sign as that of a wavelength change over time of said chirp light and causes a propagation delay due to the wavelength dispersion to said modulated optical signal.

10. An apparatus according to claim 9, wherein an equation
T0+(D×L)/(N−1)=T1/N
is satisfied,
where,
D: dispersion constant of said wavelength dispersion device,
L: wavelength change amount of said chirp light between said head electrical pulse and said end electrical pulse of said optical packet,
N: number of optical pulses of each of said optical packets,
T0: optical pulse period of said optical packet,
T1: packet period of said optical packet signal.

11. A method for compressing a pulse period of an optical pulse signal, comprising the steps of:
generating a chirp light of a wavelength which changes linearly from a first predetermined wavelength to a second predetermined wavelength for every predetermined number of pulses of said optical pulse signal;
converting said optical pulse signal to an electric pulse signal;
intensity-modulating said chirp light with said electric pulse signal to obtain a modulated optical signal; and
causing a propagation delay due to a wavelength dispersion to said modulated optical signal, said wavelength dispersion being of a sign opposite to that of a wavelength change over time of said chirp light.

12. A method for expanding a pulse period of an optical packet signal in which each optical packet includes a predetermined number of optical pulses, comprising the steps of:
generating a chirp light of a wavelength which changes linearly from a first predetermined wavelength to a second predetermined wavelength synchronously with a head optical pulse and an end optical pulse of each of said optical packets;
converting said optical packet signal to an electric pulse signal;
intensity-modulating said chirp light with said electric pulse signal to obtain a modulated optical signal; and
causing a propagation delay due to a wavelength dispersion to said modulated optical signal, said wavelength dispersion being of a same sign to that of a wavelength change over time of said chirp light.

13. A method for compressing a pulse period of an optical pulse signal, comprising the steps of:
generating a chirp light of a wavelength which changes linearly from a first predetermined wavelength to a second predetermined wavelength for every predetermined number of pulses of said optical pulse signal;
generating a wavelength-converted optical signal by wavelength-converting said optical pulse signal with said chirp light; and
causing a propagation delay due to a wavelength dispersion to said modulated optical signal, said wavelength dispersion being of a sign opposite to that of a wavelength change over time of said chirp light.

14. A method for expanding a pulse period of an optical packet signal in which each optical packet includes a predetermined number of optical pulses, comprising the steps of:
generating a chirp light of a wavelength which changes linearly from a first predetermined wavelength to a second predetermined wavelength synchronously with a head optical pulse and an end optical pulse of each of said optical packets;
generating a wavelength-converted optical signal by wavelength-converting said optical pulse signal with said chirp light; and
causing a propagation delay due to a wavelength dispersion to said modulated optical signal, said wavelength dispersion being of a same sign to that of a wavelength change over time of said chirp light.

15. A method for generating an optical packet signal, comprising the steps of:
generating an electric pulse signal having a predetermined pulse period;
generating a chirp light of a wavelength which changes linearly from a first predetermined wavelength to a second predetermined wavelength for every predetermined number of pulses of said electric pulse signal;
intensity-modulating said chirp light with said electric pulse signal to obtain a modulated optical signal; and
causing a propagation delay due to a wavelength dispersion to said modulated optical signal, said wavelength dispersion being of a sign opposite to that of a wavelength change over time of said chirp light.

16. A method for generating an optical pulse signal, comprising the steps of:
generating an electric pulse signal having a predetermined pulse period;
generating a chirp light of a wavelength which changes linearly from a first predetermined wavelength to a second predetermined wavelength for every predetermined number of pulses of said electric pulse signal;
intensity-modulating said chirp light with said electric pulse signal to obtain a modulated optical signal; and
causing a propagation delay due to a wavelength dispersion to said modulated optical signal.

17. A method for generating an optical packet signal, comprising the steps of:
generating an electrical packet signal in which each electrical packet includes a predetermined number of electrical pulses,
generating a chirp light of a wavelength which changes linearly from a first predetermined wavelength to a second predetermined wavelength synchronously with a head electrical pulse and an end electrical pulse of each of said electrical packets;
intensity-modulating said chirp light with said electric packet signal to obtain a modulated optical signal; and
causing a propagation delay due to a wavelength dispersion to said modulated optical signal, said wavelength dispersion being of a same sign to that of a wavelength change over time of said chirp light.
